(19) United States
(12) Patent Application Publication
(10) Pub. No.: US 2005/0170143 A1
(43) Pub. Date: Aug. 4, 2005

(54) Hot melt adhesives bonding fiber

(75) Inventor: Pak Chuen Yau, Hong Kong (CN)

Correspondence Address: MERCHANT & GOULD PC, P.O. BOX 2903, MINNEAPOLIS, MN, 55402-0903, US

(73) Assignee: Bisquit Development Ltd., Kowloon Bay (HK)

(21) Appl. No.: 11/018,389

(22) Filed: Dec. 20, 2004

(30) Foreign Application Priority Data
Dec. 31, 2003 (CN) 200320123153.2

(51) Int. Cl. D06N 7/04; B32B 1/00

(52) U.S. Cl. 428/141; 428/152

(57) ABSTRACT

A hot melt adhesive bonding fiber of the invention, which comprises at least one layer of thermal activation fiber cloth, which is interposed between a first layer of material and a second layer of material. The fiber cloth has a three-dimensional shape constituted by alternate protrusions and concaves, which is bonded with the first or second layer of material by hot-pressing, perfusion, or molding injection. The composite of the invention can be used for bonding all kinds of polyurethane materials with rubber (plastic) to strengthen the bonding intension.

### FIELD OF THE INVENTION

The present invention is related to a kind of hot melt adhesives bonding fiber, which is used for manufacturing multi-layer plastic, shoe vamp, automobile or furniture fittings.

### BACKGROUND OF THE INVENTION

A traditional hot melt adhesives bonding fiber is generally attained by bonding multi-layer materials together during manufacturing process, especially the process of manufacturing shoes. Each of the materials must be bonded with another material in a required bonding strength. The bonding process is usually preformed as follows: roughening artificially, treating, sulphuring (or hotting), finalizing the design, and bonding with glue. Such as bonding process has a complicated process and a high cost. In addition, the bonding strength and shearing strength is not enough so that the shoes manufactured thereby is easily torn or broken during dress. Thus a serious problem of product quality is produced.

During the manufacturing process of automobile fittings and multi-layer composite fittings of furniture, the glue is generally used for bonding. However, the glue easily become aging due to lack of enough surface adhesion between the materials so as to shorten the usage life and the overall appearance of automobile, furniture, etc.

Hence it is desired to provide a hot melt adhesives bonding fiber which can overcome the foregoing drawbacks of the prior art.

### SUMMARY OF THE INVENTION

A main object of the present invention is to provide a hot melt adhesives bonding fiber which is easily manufactured, not easily torn and has a high strength.

To achieve the above-mentioned object, a hot melt adhesives bonding fiber of the present invention, which comprises at least one layer of thermal activation fiber cloth, which is interposed between a first layer of material and a second layer of material.

In an embodiment, the fiber cloth has a three-dimensional shape constituted by alternate protrusions and concaves, which is bonded with the first or second layer of material by hot-pressing, perfusion, or molding injection.

Comparing with the prior art, because the protrusions and concaves on the fiber cloth can bonded with the first and second layer of material so as to enlarge the bonding area and accordingly increase the bonding strength. In addition, the shearing strength of the composite is increased because of the shearing strength of the fiber cloth.

Furthermore, when using the composite of the invention for manufacturing shoes, the shearing strength of the shoe vamp will exceed that of traditional shoes. Also, the invention can omit a lot of manufacturing steps and thus simply the manufacturing process and thus saving a lot of time. When using the composite of the invention for manufacturing automobile and furniture fittings, the aging time will be stayed because integrally forming the fiber cloth with the first and second materials will increase the bonding strength between the fittings and the glue.

For the purpose of making the invention easier to understand, one particular embodiment thereof will now be described with reference to the appended drawings in which:

### DESCRIPTION OF THE DRAWINGS

FIG. 1 is a schematic view of showing a structure of a hot melt adhesive bonding fiber of the present invention.

### DETAILED DESCRIPTION OF THE INVENTION

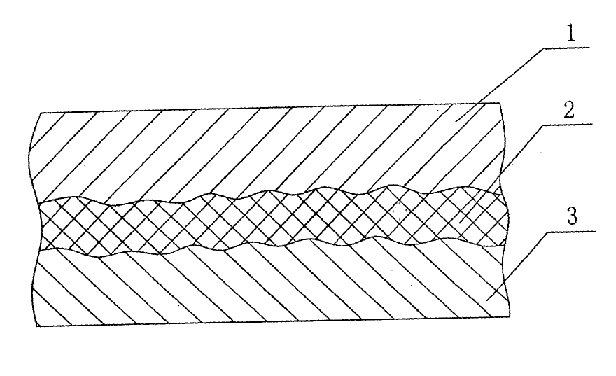

According to an embodiment of the present invention, referring to FIGS. 1, a hot melt adhesive bonding fiber. The materials comprise at least one layer of thermal activation fiber cloth 2, which is interposed between a first layer of material 1 and a second layer of material 2. The fiber cloth 2 has a three-dimensional shape constituted by alternate protrusions and concaves.

During manufacturing process, the fiber cloth 2 can be bonded with a first kind of material on one side thereof by a traditional method, such as hot-pressing, perfusion, or molding injection, and then bonded with a second kind of material in the other side thereof by perfusion, molding injection or hot-pressing. In the present invention, the first and second kind of material can be metal, plastic or wood material. The composite of the invention can be used for bonding all kinds of polyurethane materials with rubber (plastic) to strengthen the bonding intension.

It is understood that the invention may be embodied in other forms without departing from the spirit thereof. Thus, the present example and embodiment are to be considered in all respects as illustrative and not restrictive, and the invention is not to be limited to the details given herein.

1. A hot melt adhesive bonding fiber, which comprising
at least one layer of thermal activation fiber cloth, which is interposed between a first layer of material and a second layer of material.

2. The composite as claimed in claim 1, wherein the fiber cloth has a three-dimensional shape constituted by alternate protrusions and concaves.

3. The composite as claimed in claim 1, wherein the fiber cloth is bonded with the first or second layer of material by hot-pressing, perfusion, or molding injection.

4. The composite as claimed in claim 1, wherein the first and second layer of material is plastic, metal or wood material.
